(19) United States
(12) Patent Application Publication
(10) Pub. No.: US 2020/0242148 A1
(43) Pub. Date: Jul. 30, 2020

(54) NATURAL LANGUAGE PROCESSING USING ONTOLOGY MAPPING

(71) Applicant: KONINKLIJKE PHILIPS N.V., EINDHOVEN (NL)

(72) Inventors: Alexander Ryan Mankovich, Somerville, MA (US); Woei-Jye Yee, Boston, MA (US)

(21) Appl. No.: 16/650,157

(22) PCT Filed: Sep. 19, 2018
(86) PCT No.: PCT/EP2018/075263

§ 371 Date: Mar. 24, 2020

Related U.S. Application Data
(60) Provisional application No. 62/565,439, filed on Sep. 29, 2017.
(60) Provisional application No. 62/615,530, filed on Jan. 10, 2018.

(51) Int. Cl. G06F 16/33; G06F 16/31

(52) U.S. Cl. CPC G06F 16/3338; G06F 16/31

(57) ABSTRACT

Methods and systems for constructing a query. The methods and systems described herein provide novel techniques for constructing queries by mapping ontologies to each other. Accordingly, systems and methods described herein may map an otherwise unmappable term to an ontology in order to capitalize on the knowledge contained therein.

### TECHNICAL FIELD

Embodiments described herein generally relate to systems and methods for natural language processing and, more particularly but not exclusively, to systems and methods for natural language processing using ontology mapping.

### BACKGROUND

There are many existing ontologies that serve as taxonomies for organizing domain-specific knowledge. Specific ontologies in the medical domain include, but are not limited to, SNOMED®, OMIM®, and MeSH.

There are many ways that terms, and particularly medical terms, can be represented in a specific ontology. For example, terms can be represented by multiple semantic equivalents (e.g., “lung malignancy” and “lung cancer.”). Even if an ontology does not include an exact match for a particular term, it is possible that there is a semantic match between a similar entry in the ontology and the term.

However, leveraging these ontologies to, e.g., relate incoming queries to existing knowledge, often requires rigorous human-mediated interpretation and intervention to determine how certain terms are related to various ontology entries. These existing ontologies therefore require additional intelligence to maximize the mapping of new terms to existing terms in an ontology. Additionally, there are often inconsistences among terms and their meanings across different domains or medical areas.

A need exists, therefore, for systems and methods for mapping terms to ontology entries that overcome the disadvantages of existing techniques.

### SUMMARY

This summary is provided to introduce a selection of concepts in a simplified form that are further described below in the Detailed Description section. This summary is not intended to identify or exclude key features or essential features of the claimed subject matter, nor is it intended to be used as an aid in determining the scope of the claimed subject matter.

According to one aspect, embodiments relate to a method for constructing a query. The method includes receiving a first search term for use in constructing a query against a plurality of records; locating a first entry associated with the first search term in a first ontology data structure associated with a first ontology, wherein the first entry includes a first reference to a second entry in the first ontology data structure; retrieving a second search term based on the first reference to the second entry; constructing the query including the second search term; and executing the query against the plurality of records.

In some embodiments, the method further includes identifying a first path traversing the first ontology data structure that identifies the first reference to the second entry. In some embodiments, the method further includes locating a third entry associated with the first search term in a second ontology data structure associated with a second ontology that is different than the first ontology; applying the identified first path to the second ontology data structure; and following the identified first path in the second ontology data structure to locate a fourth entry in the second ontology data structure, wherein retrieving the second search term includes reading the second search term from the fourth entry in the second ontology data structure.

In some embodiments, the second entry is a hypernym of the first entry, a hyponym of the first entry, or a synonym of the first entry.

In some embodiments, the second entry includes a second reference to a third entry in the first ontology data structure, and retrieving the second search term includes reading the second search term from the third entry.

In some embodiments, the method further includes, upon determining that the first search term does not match the second search term, calculating an edit distance to convert the second search term to the first search term; and receiving at least one suggested entry based on the calculated edit distance. In some embodiments, receiving the at least one suggested entry based on the calculated edit distance includes receiving a score associated with the at least one suggested entry.

According to another aspect, embodiments relate to a system for constructing a query. The system includes an interface for receiving a first search term for use in constructing a query against a plurality of records; and a processor executing instructions stored a memory to locate a first entry associated with the first search term in a first ontology data structure associated with a first ontology, wherein the first entry includes a first reference to a second entry in the first ontology data structure; retrieve a second search term based on the first reference to the second entry; construct the query including the second search term; and execute the query against the plurality of records.

In some embodiments, the processor is further configured to identify a first path traversing the first ontology data structure that identifies the first reference to the second entry. In some embodiments, the processor is further configured to locate a third entry associated with the first search term in a second ontology data structure associated with a second ontology that is different than the first ontology; apply the identified first path to the second ontology data structure; and follow the identified first path in the second ontology data structure to locate a fourth entry in the second ontology data structure, wherein retrieving the second search term includes reading the second search term from the fourth entry in the second ontology data structure.

In some embodiments, the second entry is a hypernym of the first entry, a hyponym of the first entry, or a synonym of the first entry.

In some embodiments, the second entry includes a second reference to a third entry in the first ontology data structure, and retrieving the second search term includes reading the second search term from the third entry.

In some embodiments, the processor is further configured to, upon determining that the first search term does not match the second search term, calculate an edit distance to convert the second search term to the first search term; and provide at least one suggested entry based on the calculated edit distance. In some embodiments, the processor additionally provides a score associated with the at least one suggested entry.

According to yet another aspect, embodiments relate to a computer readable medium containing computer-executable instructions for constructing a query. The medium includes computer executable instructions for receiving a first search term for use in constructing a query against a plurality of records; computer executable instructions for locating a first entry associated with the first search term in a first ontology data structure associated with a first ontology, wherein the first entry includes a first reference to a second entry in the first ontology data structure; computer executable instructions for retrieving a second search term based on the first reference to the second entry; computer executable instructions for constructing the query including the second search term; and computer executable instructions for executing the query against the plurality of records.

### BRIEF DESCRIPTION OF DRAWINGS

Non-limiting and non-exhaustive embodiments of the embodiments herein are described with reference to the following figures, wherein like reference numerals refer to like parts throughout the various views unless otherwise specified.

FIG. 1 illustrates a system for constructing a query in accordance with one embodiment;

FIG. 2 illustrates the traversal of an ontology data structure in accordance with one embodiment;

FIG. 3 illustrates the traversal of an ontology data structure in accordance with another embodiment;

FIG. 4 highlights the traversal path of FIG. 2 in accordance with one embodiment;

FIG. 5 illustrates the path of FIG. 4 applied to a second ontology data structure in accordance with one embodiment;

FIG. 6 depicts flowchart of a method for constructing a query in accordance with one embodiment;

FIG. 7 depicts a flowchart of a method for constructing a query in accordance with another embodiment; and

FIG. 8 depicts a flowchart of a method for constructing a query in accordance with yet another embodiment.

### DETAILED DESCRIPTION

Various embodiments are described more fully below with reference to the accompanying drawings, which form a part hereof, and which show specific exemplary embodiments. However, the concepts of the present disclosure may be implemented in many different forms and should not be construed as limited to the embodiments set forth herein; rather, these embodiments are provided as part of a thorough and complete disclosure, to fully convey the scope of the concepts, techniques and implementations of the present disclosure to those skilled in the art. Embodiments may be practiced as methods, systems or devices. Accordingly, embodiments may take the form of a hardware implementation, an entirely software implementation or an implementation combining software and hardware aspects. The following detailed description is, therefore, not to be taken in a limiting sense.

Reference in the specification to “one embodiment” or to “an embodiment” means that a particular feature, structure, or characteristic described in connection with the embodiments is included in at least one example implementation or technique in accordance with the present disclosure. The appearances of the phrase “in one embodiment” in various places in the specification are not necessarily all referring to the same embodiment. The appearances of the phrase “in some embodiments” in various places in the specification are not necessarily all referring to the same embodiments.

Some portions of the description that follow are presented in terms of symbolic representations of operations on non-transient signals stored within a computer memory. These descriptions and representations are used by those skilled in the data processing arts to most effectively convey the substance of their work to others skilled in the art. Such operations typically require physical manipulations of physical quantities. Usually, though not necessarily, these quantities take the form of electrical, magnetic or optical signals capable of being stored, transferred, combined, compared and otherwise manipulated. It is convenient at times, principally for reasons of common usage, to refer to these signals as bits, values, elements, symbols, characters, terms, numbers, or the like. Furthermore, it is also convenient at times, to refer to certain arrangements of steps requiring physical manipulations of physical quantities as modules or code devices, without loss of generality.

However, all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system memories or registers or other such information storage, transmission or display devices. Portions of the present disclosure include processes and instructions that may be embodied in software, firmware or hardware, and when embodied in software, may be downloaded to reside on and be operated from different platforms used by a variety of operating systems.

The present disclosure also relates to an apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each may be coupled to a computer system bus. Furthermore, the computers referred to in the specification may include a single processor or may be architectures employing multiple processor designs for increased computing capability.

The processes and displays presented herein are not inherently related to any particular computer or other apparatus. Various general-purpose systems may also be used with programs in accordance with the teachings herein, or it may prove convenient to construct more specialized apparatus to perform one or more method steps. The structure for a variety of these systems is discussed in the description below. In addition, any particular programming language that is sufficient for achieving the techniques and implementations of the present disclosure may be used. A variety ofprogramming languages may be used to implement the present disclosure as discussed herein.

In addition, the language used in the specification has been principally selected for readability and instructional purposes and may not have been selected to delineate or circumscribe the disclosed subject matter. Accordingly, the present disclosure is intended to be illustrative, and not limiting, of the scope of the concepts discussed herein.

Document matching and search algorithms using terms of interest benefit from the use of domain-specific ontologies for identifying similar or related terms. For example, automated processes for determining clinical trial eligibility typically return a list of candidates who have a specified disease or other condition. The quantity and quality of results can be augmented by also including candidates whose medical records use synonyms for the specified disease, or have conditions that subsume the specified disease. While this method can be effective when the input term and its related terms are included in a particular ontology, this may not always be the case.

Embodiments of the systems and methods described herein provide novel techniques for e.g., constructing queries, using a plurality of ontologies. Accordingly, systems and methods described herein may map a term using a first ontology to another ontology in order to capitalize on relevant knowledge.

Features of various embodiments may be implemented in a number of applications. One application may be in the realm of clinical trial matching in which multiple relevant queries are generated based on a single, user-supplied query. For example, if a single query term yields insufficient matches, the systems and methods described herein may search through particular gene and disease ontologies for synonyms and hypernyms for the original user-supplied query. These synonyms, hyponyms, and/or hypernyms may be generated based on exact and/or inexact matches to the entered query term(s).

The systems and methods described herein may then create multiple queries involving these hypernyms, hyponyms, and/or synonyms. These queries may then be supplied to a clinical trial matching tool to yield more results. An additional heuristic can prioritize the search query results.

In existing techniques, a user may enter a term of interest (such as a disease-related term) into a tool that returns clinical documents relevant to that term. However, this exact term may not exist in an ontology data structure as a synonym, hyponym, or hypernym for other entries in the ontology. Without the ability to locate the term of interest and related terms in the ontology, existing techniques cannot return results for other, possibly more relevant disease terms. It is also possible that the user enters a term that does not appear at all in the document corpus or the associated ontology due to incorrect spelling, minor formatting differences, or the over-specificity of the disease.

The systems and methods described herein may first pre-process the entered term. In some cases, the pre-processed term can then be mapped to the ontology. Then, a search through the primary ontology may be mapped to searches in other ontologies via similar degrees of separation (discussed below). A list of related terms may be stored and appended to any nearest neighbors identified in the ontology by machine learning. Suggestions of the intended query term may be made to the user based on the identified terms.

In other applications, the systems and methods described herein may organize the information about a particular patient contained in their electronic health records (EHRs). A single patient may have a large number of health records that describe their current and historic ailments. These data records are generally described in unstructured, natural language form.

The systems and methods described herein may apply extraction techniques based on keyword matching to obtain all mentions of disease terms from the patient's EHRs. The findings may then be treated as terms to be located in an ontology. Once the relative positions of the terms found in the patient's EHRs are obtained, the systems and methods described herein may calculate their degree of separation (discussed below) from one another. The systems and methods described herein may then organize the EHR documents that include the terms based on their degrees of separation in the ontology.

This organization has the advantage of helping physicians browse quickly through all documents relevant to, for example, a particular disease of interest. This allows physicians or other medical personnel to cut through irrelevant records and focus on only the main disease(s) of interest.

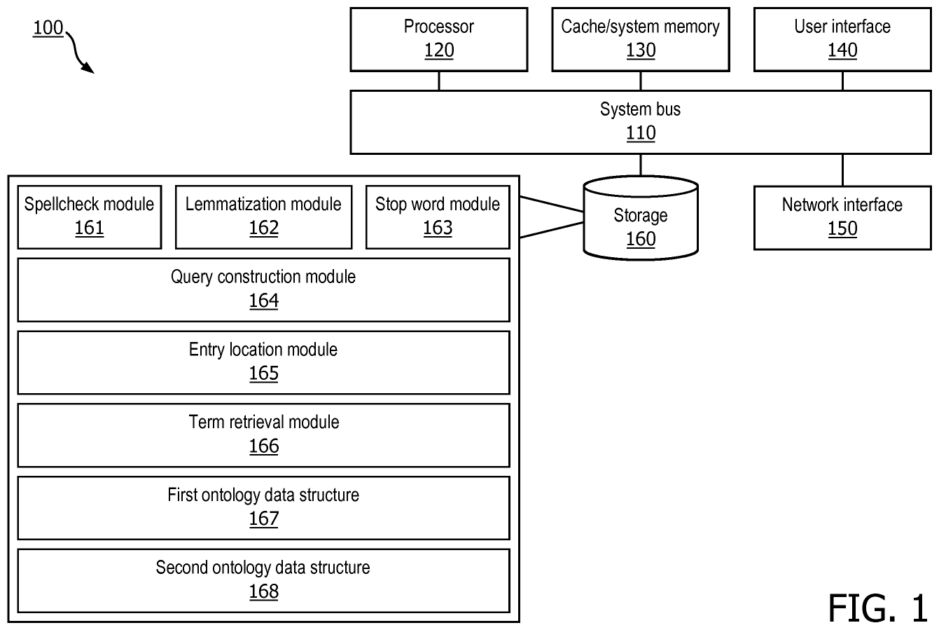

FIG. 1 illustrates a system 100 for constructing a query in accordance with one embodiment. The system 100 may include a processor 120, memory 130, a user interface 140, a network interface 150, and storage 160 interconnected via one or more system buses 110. It will be understood that FIG. 1 constitutes, in some respects, an abstraction and that the actual organization of the system 100 and the components thereof may differ from what is illustrated.

The processor 120 may be any hardware device capable of executing instructions stored on memory 130 and/or in storage 160, or otherwise any hardware device capable of processing data. As such, the processor 120 may include a microprocessor, field programmable gate array (FPGA), application-specific integrated circuit (ASIC), or other similar devices.

The memory 130 may include various non-transient memories such as, for example L1, L2, or L3 cache or system memory. As such, the memory 130 may include static random access memory (SRAM), dynamic RAM (DRAM), flash memory, read only memory (ROM), or other similar memory devices and configurations.

The user interface 140 may include one or more devices for enabling communication with a user. For example, the user interface 140 may include a display, a mouse, and a keyboard for receiving user commands. In some embodiments, the user interface 140 may include a command line interface or graphical user interface that may be presented to a remote terminal via the network interface 150. The user interface 140 may execute on a user device such as a PC, laptop, tablet, mobile device, or the like, and may enable a user to input search terms, for example.

The network interface 150 may include one or more devices for enabling communication with other remote devices. For example, the network interface 150 may include a network interface card (NIC) configured to communicate according to the Ethernet protocol. Additionally, the network interface 150 may implement a TCP/IP stack for communication according to the TCP/IP protocols. Various alternative or additional hardware or configurations for the network interface 150 will be apparent.

The storage 160 may include one or more machine-readable storage media such as read-only memory (ROM), random-access memory (RAM), magnetic disk storage media, optical storage media, flash-memory devices, or similar storage media. In various embodiments, the storage 160 may store instructions or modules for execution by the processor 120 or data upon which the processor 120 may operate.

For example, the storage 160 may include a spellcheck module 161, a lemmatization module 162, a stop word module 163, a query construction module 164, an entry location module 165, and a term retrieval module 166. The storage 160 may also include or otherwise be in communication with one or more ontology data structures 167 and 168 associated with different onto logies.

Upon receiving one or more search terms from the user interface 140, the spellcheck module 161 may perform a first set of pre-processing steps to, for example, correct spelling errors in the entered search term(s). The spellcheck module 161 may perform this pre-processing step using standard English dictionaries, medical dictionaries, and N-grams collected from databases or other sources containing correct language use. Additionally or alternatively, the spellcheck module 161 may apply a Bayesian approximation of correction candidates within, e.g., 2 edit distances using the N-grams to obtain the best results.

The lemmatization module 162 may generate lemmas for each corrected word in the query. For example, “tumours in the lungs” may yield “tumour in the lung,” and “mutated EGFR gene” may yield “mutate EGFR gene.”

Although the effect of stemming/lemmatization tends to be small as the morphological variants of disease terms tend to be limited, this lemmatization step nevertheless helps better abstract from a search term's particular occurrence and therefore emphasizes its invariable meaning. This step therefore improves machine learning procedures as it relaxes the stochastic dependence between features and reduces the dimensionality of the term's representations.

After lemmatization, the stop word module 163 may remove all stop words from the search terms. Stop words may include typical English prepositions and pronouns, as well as any other words that are commonly found in English texts of any topic. The stop word module 163 may additionally filter the lemmas to remove rare, idiosyncratic words. The stop word module 163 may consult stop word lists readily obtainable from tools such as NLTK, OpenNLP, JAVA® libraries such as APACHE® Lucene, MALLET, and GATE.

The result ofthe modules 161, 162 and 163 is a machine actionable query term or terms. This machine actionable query may then be communicated to the query construction module 164.

The query construction module 164 may enter the query against at least a first ontology data structure 167 associated with a first ontology. The first ontology data structure 167 may vary and may depend on the application, the search term(s), and/or the objective of the user.

For example, disease ontologies may be well structured ontologies for describing human diseases. While several medical-related ontologies are used for insurance and billing purposes, they may also be used to accomplish the various features of the embodiments described herein.

The entry location module 165 may execute one or more traversal algorithms to perform a lookup of the queried term(s) in the first ontology data structure 167. The entry location module 165 may locate a first entry in the ontology data structure 167, such as the ontology ID, creation date, synonyms of the query term(s), hypernym(s) of the query terms, hyponym(s) of the query terms, and/or descriptions of the query term(s).

Synonyms of the first query term(s) may be stored as a list of values within a hash table of the term's associations. Hypernyms and hyponyms, however, are not often listed in toto for a given term and may require additional, recursive methods. Additionally, it is often required that at least one of either the primary hyponyms or hypernyms are listed for a given query term. Otherwise, there may not be enough data to assume such relationships.

The algorithm implemented by the entry location module 165 may, in some embodiments in which the query term(s) N has a hypernym N+1, store a key and value for the hypernym in the term's hash table.

The entry location module 165 may recursively run this algorithm for additional hypernyms N+2, N+3, etc., to traverse the parental lineage until the root hypernym is reached in the hierarchy. The term retrieval module 166 may then retrieve a particular term or terms for use in constructing a query.

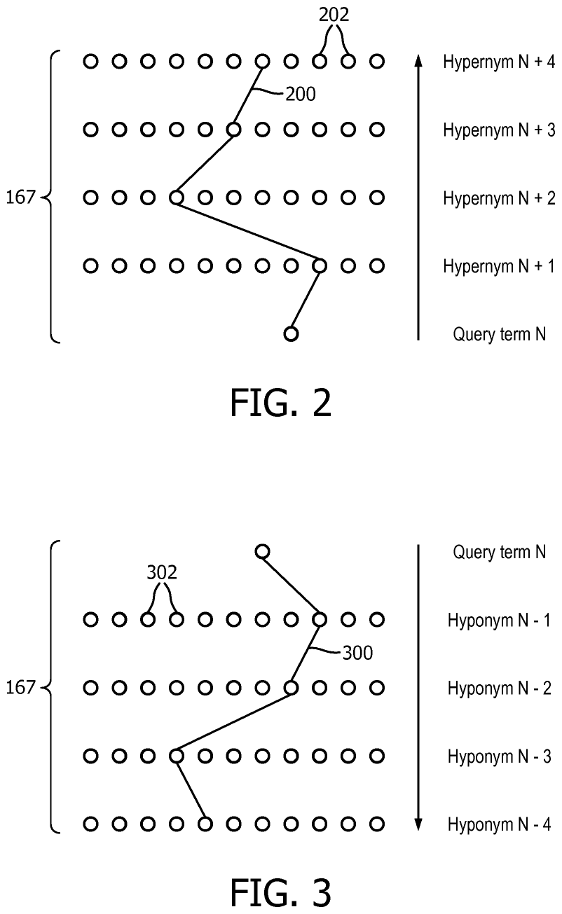

FIG. 2 illustrates the traversal of the first ontology data structure 167 in accordance with one embodiment. As seen in FIG. 2, a path 200 (represented by several line segments connecting certain nodes 202) traverses the ontology data structure 167 to identify hypernyms N+1, N+2, N+3, and N+4. Each node 202 may represent a certain term or terms associated with or otherwise relevant to the query term N.

Similarly, to map hyponyms, the entry location module 165 traverses the ontology hash table in the opposite direction. If any hypernym exists, the canonical term is added as a hyponym for the hypernym term in the hash table. This child lineage can likewise be recursively traversed until the root hyponym is returned. Continuing this approach recursively will either reach a desirable level of specificity or end with a terminating node of a tree.

FIG. 3 illustrates the traversal of the first ontology data structure 167 to find hyponyms in accordance with one embodiment. As seen in FIG. 3, a path 300 (represented by several line segments connecting certain nodes 302) traverses the ontology data structure 167 to identify hyponyms N−1, N−2, N−3, and N−4. Each node 302 may represent a certain term or terms associated with or otherwise relevant to the query term N.

When a search query term alone fails to yield a result, a less specific query may be performed in its place. A traversal upwards (i.e., to find hypernyms, as in FIG. 2) facilitates the creation of these additional queries. When the first degree hypernym also fails to yield results, the traversal may continue upwards in the ontology in a recursive manner until the root of the ontology (i.e., the root of the ontology tree) is reached or until a sufficient number of results are returned.

There may also be cases in which a search term is too generic. Additionally or alternatively, there may be cases in which a data set is mostly composed of highly specific terms without even mentioning the generic term. To return relevant results in these cases, a downward traversal such as the downward traversal of FIG. 3 may be performed. Starting with the original search term, all orthogonal terms at each level are found that are expected to have the same degree of information.

The entry location module 165 therefore essentially traverses a path in the ontology data structure 167 to identify relevant terms. This methodology is useful for medical ontologies, particularly gene and disease ontologies which tend to be organized along a tree structure. When a term is identified on the tree, traversals can be made along the branches of that tree to obtain relevant queries (as described above and shown in FIGS. 2 and 3).

The number of parent-child traversal steps required to travel from one node to another may be defined as the “degree of separation.” Accordingly, the above approaches can be used for two purposes: (1) to generate relevant terms; and (2) to identify terms on a tree given a minimum degree of separation.

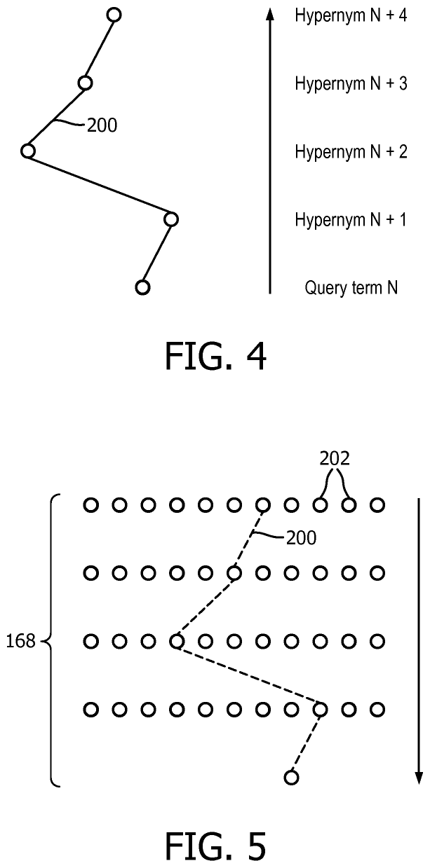

Furthermore, the systems and methods described herein may store the path that traverses the ontology data structure. For example, FIG. 4 illustrates the stored traversal path 200 of FIG. 2. This path 200 may then be used to traverse a different ontology data structure associated with a different ontology to find additional, relevant terms. Accordingly, with carefully designed automation for traversal, relevant terms (parent, child, and siblings) can be found from a query using multiple ontologies.

The path 200, when applied to other ontologies, enables the system 100 to discover new hierarchical associations. For example, the path traversed to get from term Aₓ to term A_{y} in the first ontology data structure 167 may be applied in reverse to term Bₓ in the second ontology data structure 168 to identify a possibly relevant term B_{y}. For example, FIG. 5 illustrates the path 200 of FIGS. 2 and 4 being applied to ontology 168 in reverse order.

The assembly and traversals of machine-actionable ontological relationships are helpful when the instant ontology contains exact query terms or when multiple ontologies can be mapped to each other. However, there may be cases in which there are inexact matches between query terms and terms of an ontology.

One method to address these inexact matches is to compare the word similarities between the original query term and the target term that is found using the traversal path. This comparison may include calculating the edit distances needed to convert the query term to the target term (or vice versa).

Oftentimes there is not a direct string mach. However, there may be a semantic match. An example of a semantic match may be “brain malignancy” and “brain cancer.” In the case of semantic matches, term classification techniques may enable the system to suggest terms that are largely similar. For example, ELASTICSEARCH® is an inverted indexing tool that can generate suggestions based on n-gram language models. This type of tool can therefore supplement embodiments and techniques described herein by supplying an additional suggestion function based on word co-occurrence and association frequency for a particular corpus. These suggestions can be made within the system 100 and to a user based on a score (e.g., calculated using a variety of metrics, such as the string distance from the target term to the original query).

In some embodiments, methods and systems described herein may perform classification step(s) on the query term and/or associated disease descriptions using categorization methods. These categorization methods may include, but is not limited to, K-Nearest Neighbor applied to similarity measures such as Levenshtein, cosine similarity, and Smith-Waterman, to find the most similar terms in the ontology.

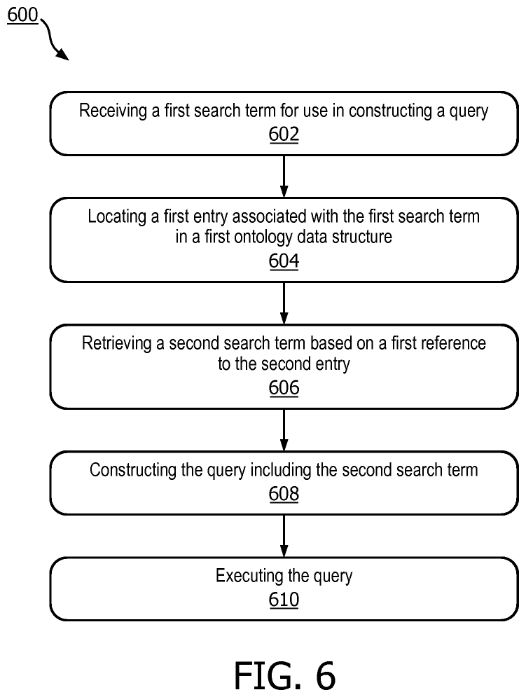

FIG. 6 depicts a flowchart of a method 600 for constructing a query in accordance with one embodiment. Step 602 involves receiving a first search term for use in constructing a query against a plurality of records. If the first search term is medical-related, the plurality of records may include those stored in gene or disease-related databases.

The first search term may be entered by a user such as medical personnel using the user interface 140 of FIG. 1. For example, the medical personnel may be interested in constructing a query using additional, relevant words related to the first search term.

Step 604 involves locating a first entry associated with the first search term in a first ontology data structure associated with a first ontology, wherein the first entry includes a first reference to a second entry in the first ontology data structure. The first ontology data structure may be in the form of a tree and relate to a first ontology. The ontology used may of course depend on the nature of the query and the objective(s) of the user.

The first entry may be located based on its similarity or match to the first search term. The located first entry may also include a first reference to a second entry in the first ontology data structure.

For example, the first reference may be an identification of a hypernym of the first search term in the ontology data structure. Similarly, the first reference may be an identification of a hyponym in the ontology data structure. Accordingly, the second entry may refer to a hypernym or a hyponym of the first search term.

Step 606 involves retrieving a second search term based on the first reference to the second entry. As mentioned above, the retrieved second search term may be, for example, a hypernym of the first search term, a hyponym of the first search term, a synonym of the first search term, a description of the first term, or the like.

Step 608 involves constructing the query including the second search term. The constructed query may include the second search term and the first search term (along with any other terms), or just the second search term. Finally, step 610 involves executing the query against the plurality of records.

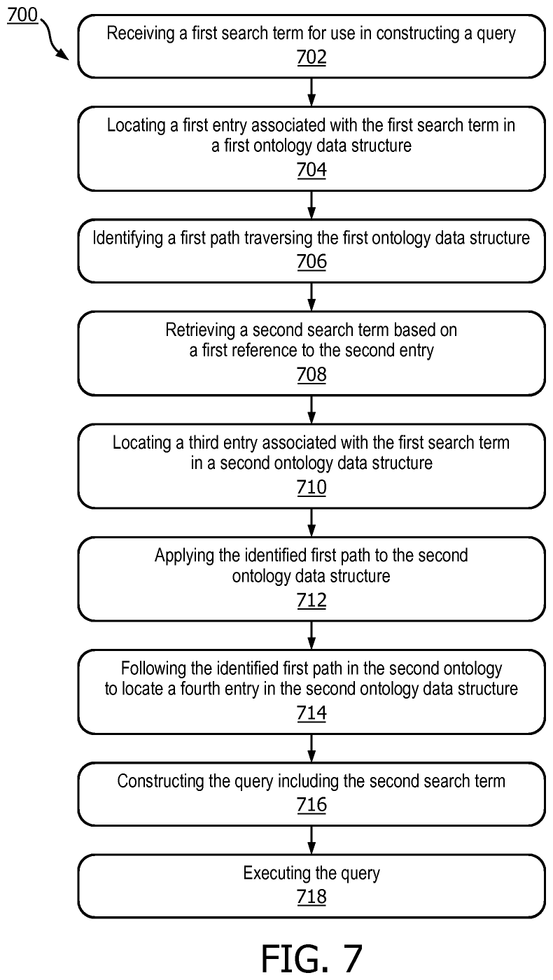

FIG. 7 depicts a flowchart of a method 700 for constructing a query in accordance with another embodiment. Steps 702-704 are similar to steps 602-604, respectively, of FIG. 6 and are not repeated here.

Step 706 involves identifying a first path traversing the first ontology data structure that identifies the first reference to the second entry. The first path may traverse the first ontology data structure to find hypernyms or hyponyms, as in FIGS. 2 and 3, respectively. The first path may traverse any number of nodes required based on the objectives of the user.

Step 708 involves retrieving a second search term based on the first reference to the second entry. This second search term may be associated with a node which the first path traverses or a node at which the first path terminates, for example.

Step 710 involves locating a third entry associated with the first search term in a second ontology data structure associated with a second ontology that is different than the first ontology. This third entry in the second ontology data structure may include a search term related to the first or second search term.

Step 712 involves applying the identified first path to the second ontology data structure. For example, FIG. 5 illustrates a saved path 200 being applied to a second ontology data structure. In some embodiments, the root or “end” of a path in the first ontology data structure may serve as the starting point of a path in a second ontology data structure.

Step 714 involves following the identified first path in the second ontology data structure to locate a fourth entry in the second ontology data structure. The second search term retrieved in step 708 may be read from the fourth entry in the second ontology data structure. The first path applied to the second ontology may be followed in reverse order than how it was followed in the first ontology data structure. Steps 716 and 718 are similar to steps 608 and 610, respectively, of FIG. 6 and are not repeated here.

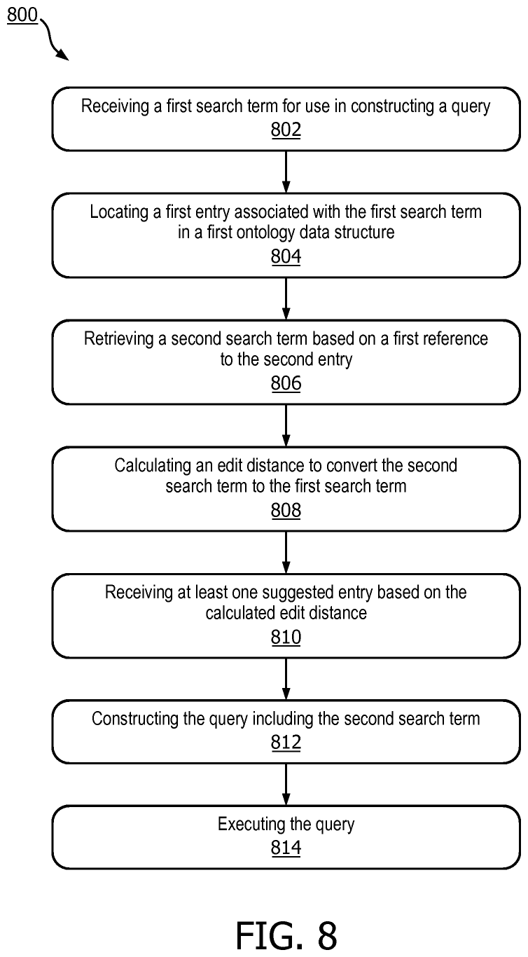

FIG. 8 depicts a flowchart of a method 800 for constructing a query in accordance with another embodiment. Steps 802-806 are similar to steps 602-606, respectively, of FIG. 6 and are not repeated here.

Step 808 involves, upon determining that the first search term does not match the second search term, calculating an edit distance to convert the second search term to the first search term. As mentioned previously, there may be instances in which the target term (i.e., the retrieved second search term), does not match the first search term. In this scenario, the processor 120 may calculate the edit distance needed to convert the target term to the first search term.

Step 810 involves receiving at least one suggested entry based on the calculated edit distance. For example, the second search term may be one that has the smallest edit distance. Additionally, the received suggested entry may be associated with a score that indicates how similar terms are to each other (e.g., the higher the score, the more similar the terms are to each other). Terms with the highest scores or terms with scores exceeding a threshold may be returned to a user for use in a query. Steps 812-814 are similar to steps 608-610, respectively, of FIG. 6 and are not repeated here.

The methods, systems, and devices discussed above are examples. Various configurations may omit, substitute, or add various procedures or components as appropriate. For instance, in alternative configurations, the methods may be performed in an order different from that described, and that various steps may be added, omitted, or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims.

Embodiments of the present disclosure, for example, are described above with reference to block diagrams and/or operational illustrations of methods, systems, and computer program products according to embodiments of the present disclosure. The functions/acts noted in the blocks may occur out of the order as shown in any flowchart. For example, two blocks shown in succession may in fact be executed substantially concurrent or the blocks may sometimes be executed in the reverse order, depending upon the functionality/acts involved. Additionally, or alternatively, not all of the blocks shown in any flowchart need to be performed and/or executed. For example, if a given flowchart has five blocks containing functions/acts, it may be the case that only three of the five blocks are performed and/or executed. In this example, any of the three of the five blocks may be performed and/or executed.

A statement that a value exceeds (or is more than) a first threshold value is equivalent to a statement that the value meets or exceeds a second threshold value that is slightly greater than the first threshold value, e.g., the second threshold value being one value higher than the first threshold value in the resolution of a relevant system. A statement that a value is less than (or is within) a first threshold value is equivalent to a statement that the value is less than or equal to a second threshold value that is slightly lower than the first threshold value, e.g., the second threshold value being one value lower than the first threshold value in the resolution of the relevant system.

Specific details are given in the description to provide a thorough understanding of example configurations (including implementations). However, configurations may be practiced without these specific details. For example, well-known circuits, processes, algorithms, structures, and techniques have been shown without unnecessary detail in order to avoid obscuring the configurations. This description provides example configurations only, and does not limit the scope, applicability, or configurations of the claims. Rather, the preceding description of the configurations will provide those skilled in the art with an enabling description for implementing described techniques. Various changes may be made in the function and arrangement of elements without departing from the spirit or scope of the disclosure.

Having described several example configurations, various modifications, alternative constructions, and equivalents may be used without departing from the spirit ofthe disclosure. For example, the above elements may be components of a larger system, wherein other rules may take precedence over or otherwise modify the application of various implementations or techniques of the present disclosure. Also, a number of steps may be undertaken before, during, or after the above elements are considered.

Having been provided with the description and illustration of the present application, one skilled in the art may envision variations, modifications, and alternate embodiments falling within the general inventive concept discussed in this application that do not depart from the scope of the following claims.

1. A method for constructing a query and returning records of relevance to that query, the method comprising:
receiving a first search term for use in constructing a query against a plurality of records;
locating a first entry associated with the first search term in a first ontology data structure associated with a first ontology, wherein the first entry includes a first reference to a second entry in the first ontology data structure;
retrieving a second search term based on the first reference to the second entry;
constructing the query including the second search term; and
executing the query against the plurality of records and returning records of relevance.

2. The method of claim 1 further comprising:
identifying a first path traversing the first ontology data structure that identifies the first reference to the second entry.

3. The method of claim 2 further comprising:
locating a third entry associated with the first search term in a second ontology data structure associated with a second ontology that is different than the first ontology;
applying the identified first path to the second ontology data structure; and
following the identified first path in the second ontology data structure to locate a fourth entry in the second ontology data structure, wherein retrieving the second search term includes reading the second search term from the fourth entry in the second ontology data structure.

4. The method of claim 1 wherein the second entry is a hypernym of the first entry, a hyponym of the first entry, or a synonym of the first entry.

5. The method of claim 1 wherein the second entry includes a second reference to a third entry in the first ontology data structure, and retrieving the second search term includes reading the second search term from the third entry.

6. The method of claim 1 further comprising, upon determining that the first search term does not match the second search term:
calculating an edit distance to convert the second search term to the first search term; and
receiving at least one suggested entry based on the calculated edit distance.

7. The method of claim 6 wherein receiving the at least one suggested entry based on the calculated edit distance includes receiving a score associated with the at least one suggested entry.

8. A system for constructing a query and returning records of relevance to that query, the system comprising:
an interface for receiving a first search term for use in constructing a query against a plurality of records; and
a processor executing instructions stored a memory to:
locate a first entry associated with the first search term in a first ontology data structure associated with a first ontology, wherein the first entry includes a first reference to a second entry in the first ontology data structure;
retrieve a second search term based on the first reference to the second entry;
construct the query including the second search term; and
execute the query against the plurality of records and returning records of relevance.

9. The system of claim 8 wherein the processor is further configured to identify a first path traversing the first ontology data structure that identifies the first reference to the second entry.

10. The system of claim 9 wherein the processor is further configured to:
locate a third entry associated with the first search term in a second ontology data structure associated with a second ontology that is different than the first ontology;
apply the identified first path to the second ontology data structure; and
follow the identified first path in the second ontology data structure to locate a fourth entry in the second ontology data structure, wherein retrieving the second search term includes reading the second search term from the fourth entry in the second ontology data structure.

11. The system of claim 8 wherein the second entry is a hypernym of the first entry, a hyponym of the first entry, or a synonym of the first entry.

12. The system of claim 8 wherein the second entry includes a second reference to a third entry in the first ontology data structure, and retrieving the second search term includes reading the second search term from the third entry.

13. The system of claim 8 wherein the processor is further configured to, upon determining that the first search term does not match the second search term:
calculate an edit distance to convert the second search term to the first search term; and
provide at least one suggested entry based on the calculated edit distance.

14. The system of claim 13 wherein processor additionally provides a score associated with the at least one suggested entry.

15. A computer readable medium containing computer-executable instructions for constructing a query and returning records of relevance to that query, the medium comprising:
computer executable instructions for receiving a first search term for use in constructing a query against a plurality of records;
computer executable instructions for locating a first entry associated with the first search term in a first ontology data structure associated with a first ontology, wherein the first entry includes a first reference to a second entry in the first ontology data structure;
computer executable instructions for retrieving a second search term based on the first reference to the second entry;
computer executable instructions for constructing the query including the second search term; and
computer executable instructions for executing the query against the plurality of records.
